(19) United States
(12) Patent Application Publication
(10) Pub. No.: US 2015/0088462 A1
(43) Pub. Date: Mar. 26, 2015

(54) HARDWARE PERFORMANCE EVALUATION METHOD AND SERVER

(71) Applicant: Tencent Technology (Shenzhen) Company Limited, Shenzhen (CN)

(72) Inventors: Haibo Wang, Shenzhen (CN); Weiguo Zhao, Shenzhen (CN); Zongkai Zhang, Shenzhen (CN); Xiaowen Liang, Shenzhen (CN); Jin Fan, Shenzhen (CN)

(73) Assignee: Tencent Technology (Shenzhen) Company Limited

(21) Appl. No.: 14/558,394

(22) Filed: Dec. 2, 2014

Related U.S. Application Data
(63) Continuation of application No. PCT/CN2013/076882, filed on Jun. 6, 2013.

(30) Foreign Application Priority Data
Jun. 7, 2012 (CN) 201210186505.2

(51) Int. Cl. G06F 11/34

(52) U.S. Cl. CPC G06F 11/3428
USPC 702/186

(57) ABSTRACT

Disclosed are a hardware performance evaluation method and server. The method includes: a remote server acquiring a hardware parameter of a detected device remotely through a detection device; according to the hardware parameter and a preset weight, calculating a performance point value of the detected device; and returning the calculation result to a detection terminal The technical solution provided in the present invention has a fast calculation speed of performance evaluation, less resource consumption, and higher stability and reliability.

### CROSS-REFERENCES TO RELATED APPLICATIONS

The present application claims the priority and is a continuation of PCT/CN2013/076882, filed on Jun. 6, 2013 and entitled “METHOD AND SERVER FOR EVALUATING HARDWARE PERFORMANCE”, which claims the priority to Chinese Patent Application No. 201210186505.2, entitled “METHOD AND SERVER FOR EVALUATING HARDWARE PERFORMANCE”, filed on Jun. 7, 2012 with the Chinese State Intellectual Property Office, which are incorporated herein by reference in their entireties.

### FIELD

The disclosure relates to the technique for evaluating hardware performance.

### BACKGROUND

In a hardware evaluating technology, a hardware test for a computer, i.e., a calculation of speed and performance of the computer, may be achieved by running a performance test program such as a specific calculation task on the computer to measure and calculate speed and effect of accomplishing the task. The calculation process is complex since it includes a large amount of floating point operation or three-dimensional model operation, resulting in consuming a mass of resources. Therefore, the performance evaluation depends on the running condition of the computer, and accuracy of the evaluation is susceptible to interference, and stability of the evaluation is easily affected.

### SUMMARY

According to the disclosure, it is provided a method for evaluating hardware performance and a server thereof to solve at least one of the above problems.

According to the disclosure, it is provided a method for evaluating hardware performance, including:
providing a communication connection between a remote server and a detection terminal;
acquiring, by the remote server, a hardware parameter of an electronic device detected by the detection terminal;
calculating, by the remote server, a performance score of the electronic device based on the hardware parameter and a preset weight of the hardware parameter; and
returning a calculation result to the detection terminal, wherein the calculation result comprises the performance score of the electronic device.

After the process of calculating the performance score of the electronic device based on the hardware parameter and the preset weight and before the process of returning the calculation result to the detection terminal, the method further includes:
ranking multiple electronic devices based on calculated performance scores of the multiple electronic devices.

The calculation result further includes a performance ranking of the electronic devices.

The process of calculating the performance score of the device based on the hardware parameter and the preset weight of the hardware parameter includes:
calculating a performance score of an individual piece of hardware based on the hardware parameter and a parameter weight of the hardware parameter; and
calculating the performance score of the electronic device based on the performance score of the individual piece of hardware and a score weight corresponding to the performance score of the individual piece of hardware.

In the case that the individual piece of hardware has multiple parameters, the process of calculating the performance score of the individual hardware includes:
multiplying each parameter by a corresponding parameter weight; obtaining a calculation result for each hardware parameter according to the multiplying; and
adding calculation results of the multiple hardware parameters to obtain the performance score of the individual piece of hardware.

In the case that the electronic device has multiple pieces of hardware, the process of calculating the performance score of the electronic device includes:
multiplying the performance score of each piece of hardware by a corresponding score weight;
obtaining a calculation result for each piece of hardware according to the multiplying; and
adding calculating results of the multiple pieces of hardware to obtain the performance score of the electronic device.

According to the disclosure, it is also provided a server for evaluating hardware performance, including one or more processors, and memory having instructions stored thereon, the instructions, when executed by the one or more processors, cause the processors to perform operations includes:
providing a communication connection between the server and a detection terminal;
acquiring, a hardware parameter of an electronic device detected by a detection terminal;
calculating, a performance score of the electronic device based on the hardware parameter and a preset weight of the hardware parameter; and
returning a calculation result to the detection terminal, where the calculation result includes the performance score of the electronic device.

The processors further performs operations including:
ranking multiple electronic devices based on calculated performance scores of the multiple electronic devices.

The calculation result further includes a performance ranking of the electronic devices.

The processors perform operations including:
calculating a performance score of an individual piece of hardware based on the hardware parameter and a parameter weight of the hardware parameter; and
calculating the performance score of the electronic device based on the performance score of the individual piece of hardware and a score weight corresponding to the performance score of the individual piece of hardware.

In the case that the individual piece of hardware has multiple parameters, the processors multiply each parameter by a corresponding parameter weight, to obtain a calculation result for each hardware parameter, and add calculation results.

In the case that the electronic device has multiple pieces of hardware, the processors multiply the performance score of each piece of hardware by a corresponding score weight, to obtain a calculation result for each piece of hardware, and add calculation results.

According to the disclosure, it is also provided a non-transitory computer-readable storage medium storing thereon computer executable instructions which, when executed by a computer, enable the computer to perform steps of:
providing a communication connection between the server and a detection terminal;
acquiring a hardware parameter of an electronic device detected by the detection terminal;
calculating a performance score of the electronic device based on the hardware parameter and a preset weight of the hardware parameter; and
returning a calculation result to the detection terminal, where the calculation result includes the performance score of the electronic device.

According to the technical solution provided in the disclosure, after the hardware parameter of the device is acquired, the remote server obtains the performance of the device by using weight calculation. Compared with other hardware evaluating technology, a simple calculation is employed in the embodiments of the invention and therefore resource consumption can be reduced; and according to the embodiments of the invention, the performance detection is performed remotely, and thus the process of the performance detection is independent of the running of a computer, thereby increasing stability and reliability of the performance detection.

### BRIEF DESCRIPTION OF THE DRAWINGS

FIG. 1 is a flow chart of a method for evaluating hardware performance according to an embodiment of the invention;

FIG. 2 is a schematic diagram of a system including a remote server, a detection terminal and an electronic device;

FIG. 3 is a flow chart of a performance calculation in the method for evaluating hardware performance according to the embodiment as shown in FIG. 1;

FIG. 4 is a flow chart of a method for evaluating hardware performance according to an embodiment of the invention;

FIG. 5 is a schematic diagram illustrating displaying of a returned calculation result in the method for evaluating hardware performance according to the embodiment as shown in FIG. 4;

FIG. 6 is a schematic structural diagram of a server for evaluating hardware performance according to an embodiment of the invention;

FIG. 7 is a schematic structural diagram of a performance calculation module in the server for evaluating hardware performance according to the embodiment as shown in FIG. 6; and

FIG. 8 is a schematic structural diagram of a server for evaluating hardware performance according to an embodiment of the invention.

The achievement of objects, function features and advantages of the invention will be further described in conjunction with the embodiments with reference to the accompanying drawings.

### DETAILED DESCRIPTION

It should be understood that the specific embodiments described herein are merely to explain the invention and are not intended to limit the invention.

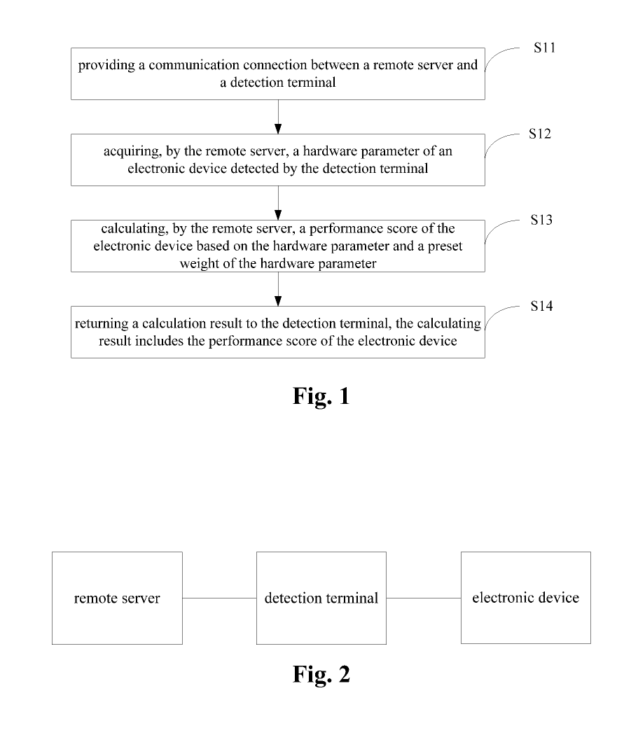

FIG. 1 is a flow chart of a method for evaluating hardware performance according to an embodiment of the invention. The method may include step S11 to step S14.

Step S11 may include providing a communication connection between a remote server and a detection terminal

Step S12 may include acquiring, by the remote server, a hardware parameter of an electronic device detected by the detection terminal

FIG. 2 illustrates a schematic structural diagram of a system including the remote server, the detection terminal and the electronic device.

Step S13 may include calculating, by the remote server, a performance score of the electronic device based on the hardware parameter and a preset weight of the hardware parameter.

An electronic device may include more than one piece of hardware, and each piece of hardware corresponds to a hardware parameter. In addition, based on the importance of each piece of hardware, the hardware parameter of each piece of hardware may correspond to a weight. In the case that the electronic device is a computer, the hardware parameter of the CPU may be larger than that of the graphic card.

Step S14 may include returning a calculation result to the detection terminal, the calculating result includes the performance score of the electronic device.

According to the present embodiment, after the hardware parameter of the electronic device is acquired, the remote server obtains the performance of the electronic device by using weight calculation. Compared with other hardware evaluation technology, a simple calculation is employed in the embodiments of the invention and therefore resource consumption can be reduced; and according to the embodiments of the invention, a performance detection is performed remotely, and thus the process of the performance detection is independent of the running of a computer, thereby increasing stability and reliability of the performance detection.

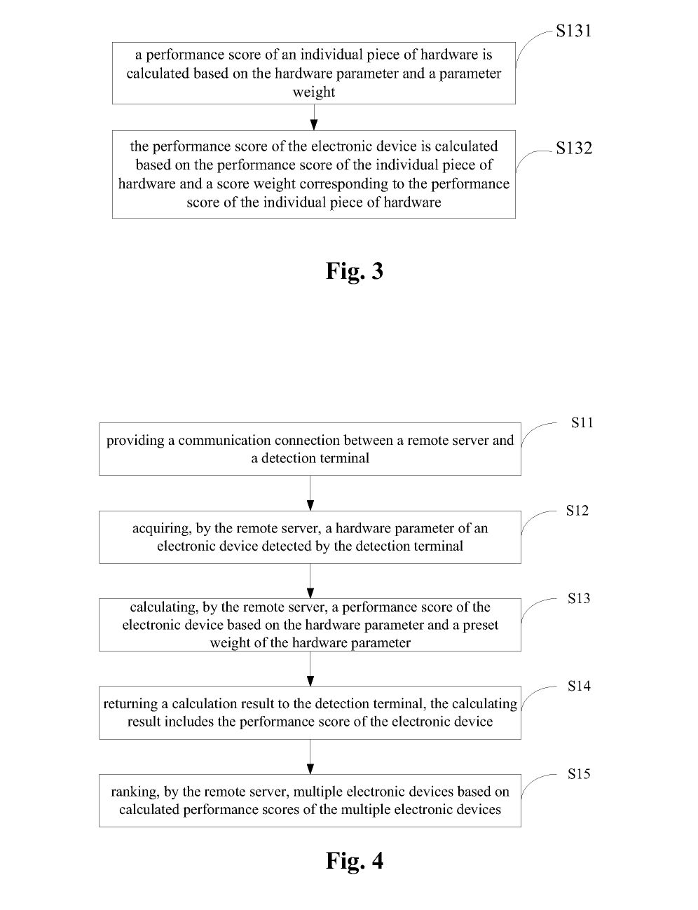

Referring to FIG. 3, the above-described step S13 may include step S131 to step S132.

Step S131 may include calculating a performance score of an individual piece of hardware based on the hardware parameter and a parameter weight.

Step S132 may include calculating the performance score of the electronic device based on the performance score of the individual piece of hardware and a score weight corresponding to the performance score of the individual piece of hardware.

The way for calculating the performance score of the electronic device by the remote server may include: firstly calculating the performance score of the each individual piece of hardware in the electronic device based on the hardware parameter and the parameter weight; and then calculating the performance score of the electronic device based on the performance score of the each individual piece of hardware and the corresponding score weight.

In the case that an individual piece of hardware has multiple parameters, a way for calculating the performance score of the individual piece of hardware includes: multiplying the multiple parameters by the corresponding parameter weights respectively and then adding derived results; and in the case that the electronic device has multiple pieces of hardware; a way for calculating the performance score of the electronic device includes: multiplying the performance scores of the multiple pieces of hardware by the corresponding score weights respectively and then adding derived results.

For example, the parameter of a processor (CPU) of the electronic device may include a main frequency (e.g., 2300 MHz), a bus frequency (e.g., 1002.2 MHz) and the number of cores (e.g., dual-core). The performance score of the processor may be expressed as: main frequency*main frequency weight+bus frequency*bus frequency weight+the number of cores*core weight. The electronic device described above generally also includes other hardware such as a mainboard, a memory, a graphic card and a hard disk. The performance scores of the hardware may be calculated sequentially, and then the performance scores of the hardware are multiplied by the corresponding score weights respectively, to obtain the performance score of the electronic device.

FIG. 4 is a flow chart of a method for evaluating hardware performance according to an embodiment of the invention. Compared with the method shown in FIG. 1, the method may further include step S15 after the step S13.

Step S15 may include ranking, by the remote server, multiple electronic devices based on calculated performance scores of the multiple electronic devices. Therefore, in the step S14, the calculation result which is returned to the detection terminal includes the performance score of the electronic device and a performance ranking of the electronic devices.

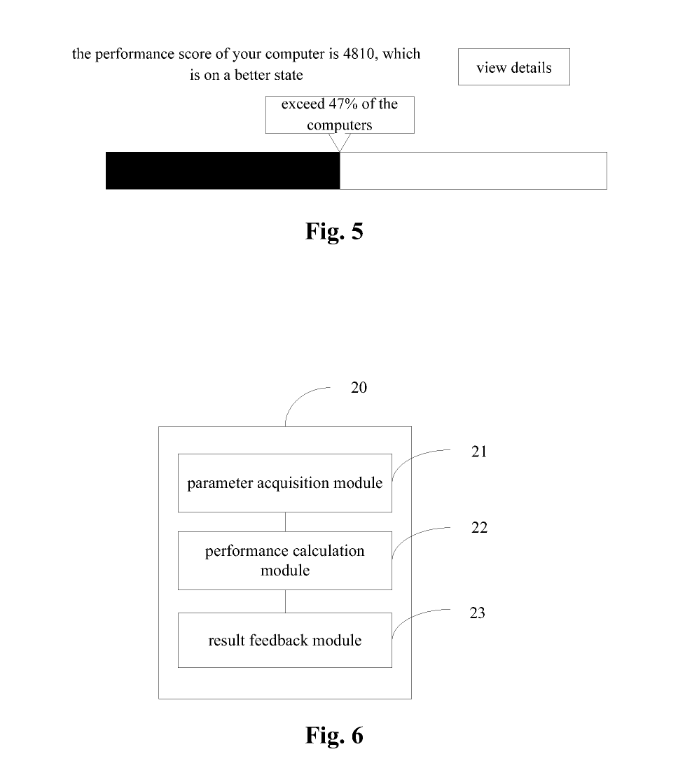

According to the embodiments of the present invention, the remote server may detect multiple electronic devices. Hence, the remote server may acquire the hardware parameters of the multiple electronic devices through the detection terminal, calculate and record the performance score of each of the electronic devices respectively, and establish a performance score database of the electronic device. Therefore, it may be achieved that the electronic devices are ranked based on the performance of the electronic devices. The remote server may further return the calculated performance score of the electronic device and the ranking of the electronic devices to the detection terminal and display the performance score (see FIG. 5). Specifically, the detection terminal may also be provided in the detected electronic device.

The technical solution provided in this embodiment of the invention has the advantages that, quick calculation speed for evaluating the performance, low resource consumption, high stability and reliability. In addition, cross comparison also can be supported, and the ranking of the electronic devices in the cross comparison can be updated at any time.

FIG. 6 is a schematic structural diagram of a server for evaluating hardware performance according to an embodiment of the invention. The server 20 may include a parameter acquisition module 21, a performance calculation module 22 and a result feedback module 23. The parameter acquisition module 21 is configured to acquire a hardware parameter of a device remotely through a detection terminal The performance calculation module 22 is configured to calculate a performance score of the device based on the hardware parameter and a preset weight. The result feedback module 23 is configured to return a calculation result to the detection terminal

According to the present embodiment, after the hardware parameter of the electronic device is acquired, the remote server obtains the performance of the device by using weight calculation. Compared with other hardware evaluating technology, a simple calculation is employed in the embodiments of the invention and therefore resource consumption can be reduced; and according to the embodiments of the invention, a performance detection is performed remotely, and thus the process of the performance detection is independent of the running of a computer, thereby increasing stability and reliability of the performance detection.

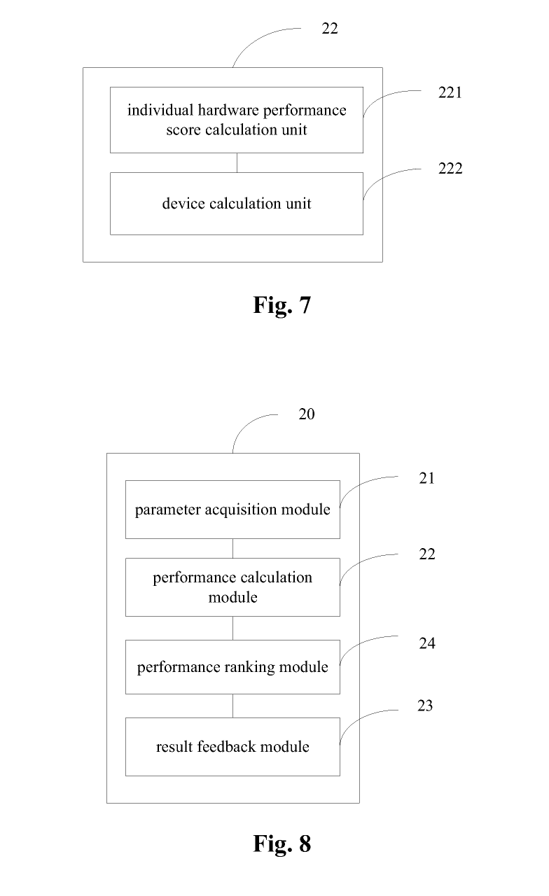

Referring to FIG. 7, the above-described performance calculation module 22 may include an individual hardware performance score calculation unit 221 and a device calculation unit 222. The individual hardware performance score calculation unit 221 is configured to calculate a performance score of an individual piece of hardware based on the hardware parameter and a parameter weight. The device calculation unit 222 is configured to calculate the performance score of the device based on the performance score of the individual piece of hardware and a score weight corresponding to the performance score of the individual piece of hardware.

The method for the remote server calculating the performance score of the electronic device may include: firstly calculating the performance score of the each individual piece of hardware in the electronic device based on the hardware parameter and the parameter weight; and then calculating the performance score of the electronic device based on the performance scores of the each individual piece of hardware and the corresponding score weight.

In the case that an individual piece of hardware has multiple parameters, a way for calculating the performance score of the individual piece of hardware includes: multiplying the multiple parameters by the corresponding parameter weights respectively and then adding derived results; and in the case that the device has multiple pieces of hardware; a way for calculating the performance score of the electronic device includes: multiplying the performance scores of the multiple pieces of hardware by the corresponding score weights respectively and then adding derived results.

For example, the parameter of a processor (CPU) of the electronic device may include a main frequency (e.g., 2300 MHz), a bus frequency (e.g., 1002.2 MHz) and the number of cores (e.g., dual-core). The performance score of the processor may be expressed as: main frequency*main frequency weight+bus frequency*bus frequency weight+the number of cores*core weight. The electronic device described above generally also includes other hardware such as a mainboard, a memory, a graphic card and a hard disk. The performance scores of the hardware may be calculated sequentially, and then the performance scores of the hardware are multiplied by the corresponding score weights respectively, to obtain the performance score of the electronic device.

FIG. 8 is a schematic structural diagram of a server for evaluating hardware performance according to an embodiment of the invention. The server 20 may further include a performance ranking module 24, which is configured to rank multiple electronic devices based on the calculated performance scores of the multiple electronic devices. Therefore, the calculation result which is returned to the detection terminal by the result feedback module according to the present embodiment includes the performance score of the electronic device and a performance ranking of the electronic devices.

According to the embodiments of the present invention, the server may detect multiple electronic devices, hence, the server may acquire the hardware parameters of the multiple electronic devices through the detection terminal, calculate and record the performance score of each of the electronic devices respectively, and establish a performance score database of the electronic device, and therefore it may be achieved that the electronic devices are ranked based on the performance of the electronic devices. The server may further return the calculated performance score of the detected electronic device and the ranking of the electronic devices to the detection terminal and display the performance score (see FIG. 4). Specifically, the detection terminal may also be provided in the detected electronic device.

The technical solution provided in this embodiment of the invention has the advantages that, quick calculation speed for evaluating the performance, low resource consumption, high stability and reliability. In addition, cross comparison also can be supported, and the ranking of the electronic devices in the cross comparison can be updated at any time.

In addition, according to the disclosure, it is also provided a program product storing thereon machine-readable instruction code. When the above-described instruction code is read and executed by a machine, the above-described method for evaluating hardware performance according to the embodiments of the invention may be executed. Accordingly, various storage media such as a disk, an optical disk, a magneto optical disk and a semiconductor memory used to load such program product is also included in the disclosure of the invention.

These above-described machine-readable storage media include but are not limited to various memories and storage units, semiconductor devices, disk units such as optical disks, magnetic disks and magneto-optical disks, and other medium suitable for storing information.

The foregoing are only preferred embodiments of the invention and therefore are not intended to limit the scope of the invention, and any equivalent structures or equivalent alternatives made based on the description and the accompanying drawings of the invention, as well as any applications made based on the disclosure which are directly or indirectly applied to other related technical field are all included in the scope of protection of the present invention.

1. A method for evaluating hardware performance, comprising:
providing a communication connection between a remote server and a detection terminal;
acquiring, by the remote server, a hardware parameter of an electronic device detected by the detection terminal;
calculating, by the remote server, a performance score of the electronic device based on the hardware parameter and a preset weight of the hardware parameter; and
returning, by the remote server, a calculation result to the detection terminal, wherein the calculation result comprises the performance score of the electronic device.

2. The method for evaluating hardware performance according to claim 1, wherein after calculating a performance score of the electronic device based on the hardware parameter and the preset weight and before returning a calculation result to the detection terminal, the method further comprises:
ranking a plurality of electronic devices based on calculated performance scores of the plurality of electronic devices.

3. The method for evaluating hardware performance according to claim 2, wherein the calculation result further comprises a performance ranking of the electronic devices.

4. The method for evaluating hardware performance according to claim 1, wherein calculating a performance score of the electronic device based on the hardware parameter and a preset weight of the hardware parameter comprises:
calculating a performance score of an individual piece of hardware based on the hardware parameter and a parameter weight of the hardware parameter; and
calculating the performance score of the electronic device based on the performance score of the individual piece of hardware and a score weight corresponding to the performance score of the individual piece of hardware.

5. The method for evaluating hardware performance according to claim 4, wherein
in the case that the individual piece of hardware has a plurality of hardware parameters, calculating a performance score of the individual piece of hardware comprises:
multiplying each hardware parameter by a corresponding parameter weight;
obtaining a calculation result for each hardware parameter according to the multiplying; and
adding calculation results of the plurality of hardware parameters to obtain the performance score of the individual piece of hardware.

6. The method for evaluating hardware performance according to claim 4, wherein
in the case that the electronic device has a plurality of pieces of hardware, calculating the performance score of the electronic device comprises:
multiplying the performance score of each piece of hardware by a corresponding score weight;
obtaining a calculation result for each piece of hardware according to the multiplying; and
adding calculation results of the plurality of pieces of hardware to obtain the performance score of the electronic device.

7. A server for evaluating hardware performance, comprising one or more processors, and memory having instructions stored thereon, the instructions, when executed by the one or more processors, cause the processors to perform operations comprising:
providing a communication connection between the server and a detection terminal;
acquiring a hardware parameter of an electronic device detected by a detection terminal;
calculating a performance score of the electronic device based on the hardware parameter and a preset weight of the hardware parameter; and
returning a calculation result to the detection terminal, wherein the calculation result comprises the performance score of the electronic device.

8. The server for evaluating hardware performance according to claim 7, wherein the processors further performs operations comprising:
ranking a plurality of electronic devices based on calculated performance scores of the plurality of electronic devices.

9. The server for evaluating hardware performance according to claim 8, wherein the calculation result further comprises a performance ranking of the electronic devices.

10. The server for evaluating hardware performance according to claim 7, wherein the processors perform operations comprising:
calculating a performance score of an individual piece of hardware based on the hardware parameter and a parameter weight of the hardware parameter; and
calculating the performance score of the electronic device based on the performance score of the individual piece of hardware and a score weight corresponding to the performance score of the individual piece of hardware.

11. The server for evaluating hardware performance according to claim 10, wherein
in the case that the individual piece of hardware has a plurality of parameters, the processors multiply each parameter by a corresponding parameter weight , to obtain a calculation result for each hardware parameter, and add calculation results.

12. The server for evaluating hardware performance according to claim 10, wherein in the case that the electronic device has a plurality of pieces of hardware, the processors multiply the performance score of each piece of hardware by a corresponding score weights, to obtain a calculation result for each piece of hardware, and add calculation results.

13. A non-transitory computer-readable storage medium storing thereon computer executable instructions which, when executed by a computer, enable the computer to perform steps of:
providing a communication connection between a remote server and a detection terminal;
acquiring, by the remote server, a hardware parameter of an electronic device detected by the detection terminal;
calculating, by the remote server, a performance score of the electronic device based on the hardware parameter and a preset weight of the hardware parameter; and
returning, by the remote server, a calculation result to the detection terminal, wherein the calculation result comprises the performance score of the electronic device.
